(19) United States
(12) Patent Application Publication
(10) Pub. No.: US 2026/0341242 A1
(43) Pub. Date: Oct. 29, 2026

(54) DISPLAY DEVICE AND METHOD OF DRIVING THE SAME

(71) Applicant: LG Display Co., Ltd., Seoul (KR)

(72) Inventors: Seung Taek OH, Paju-si (KR); Sun Yeop KIM, Paju-si (KR)

(21) Appl. No.: 19/548,660

(22) Filed: Feb. 24, 2026

(30) Foreign Application Priority Data
Apr. 29, 2025 (KR) 10-2025-0056293

(51) Int. Cl. G09G 3/34; G02F 1/1333

(52) U.S. Cl. CPC G09G 3/3426; G02F 1/13338; G09G 2330/023; G09G 2360/14

(57) ABSTRACT

A display device including a sensing area and a method of driving the same, capable of reducing power consumption of the display device. The display device includes a liquid crystal display panel including an active area and a sensing area disposed within the active area and an optical module disposed under the liquid crystal display panel and including a first light source element configured to supply light to the sensing area and an optical element configured to sense external light through the sensing area. Sub-pixels disposed in the active area of the liquid crystal display panel and sub-pixels disposed in the sensing area of the liquid crystal display panel have the same width and length, and the sub-pixels disposed in the sensing area include at least one white sub-pixel.

### CROSS REFERENCE TO RELATED APPLICATION

This application claims priority from and the benefit of Korean Patent Application No. 10-2025-0056293, filed on Apr. 29, 2025, which is hereby incorporated by reference for all purposes as if fully set forth herein.

### BACKGROUND

### FIELD

Embodiments of the invention relate generally to a display device and a method of driving the same.

### DISCUSSION OF THE BACKGROUND

Generally, a display device provides an image to a user. For example, a display device may include a liquid crystal panel disposed on a backlight unit. The liquid crystal panel may generate an image using light supplied from the backlight unit. For example, the liquid crystal panel may include sub-pixels.

The display device may include an optical module for sensing external light. For example, the optical module may include at least one of a camera or an IR sensor. The optical module may overlap a portion of the liquid crystal panel. For example, the liquid crystal panel may include an active area overlapping a light guide plate of the backlight unit and a sensing area overlapping the optical module.

The sensing area may be disposed within the active area. However, because light for image implementation is not emitted from the sensing area of the liquid crystal panel, the quality of an image provided to a user by the display device may be degraded due to a luminance deviation between the active area and the sensing area. Therefore, an auxiliary light source for supplying light to the sensing area may be provided.

However, use of the auxiliary light source for supplying light to the sensing area causes increase in power consumption. Accordingly, embodiments of the invention are directed to a display device and a method of driving the same that address this problem.

The above information disclosed in this Background section is only for understanding of the background of the inventive concepts, and, therefore, it may contain information that does not constitute prior art.

### SUMMARY

A display device including a sensing area and a method of driving the same, according to embodiments of the invention, are capable of reducing power consumption of the display device.

Additional features of the inventive concepts will be set forth in the description which follows, and in part will be apparent from the description, or may be learned by practice of the inventive concepts.

According to one or more embodiments of the invention, a display device includes a liquid crystal display panel, including an active area and a sensing area disposed within the active area, and an optical module disposed under the liquid crystal display panel, the optical module including a first light source element configured to supply light to the sensing area and an optical element configured to sense external light through the sensing area. Sub-pixels disposed in the active area of the liquid crystal display panel and sub-pixels disposed in the sensing area of the liquid crystal display panel have the same width and length, and the sub-pixels disposed in the sensing area include at least one white sub-pixel.

The sub-pixels disposed in the active area may not include a white sub-pixel.

The display device may further include a backlight unit disposed between the liquid crystal display panel and the optical module and including a light guide plate and a second light source element which is configured to supply light to the active area through the light guide plate.

One fourth of the number of sub-pixels disposed in the sensing area may include red, green, and blue sub-pixels, and three fourths of the number of sub-pixels disposed in the sensing area may include white sub-pixels.

At least one of the white sub-pixels disposed in the sensing area may emit white.

The first light source element may be driven with lower power consumption when at least one of the white sub-pixels disposed in the sensing area emits white than when all of the white sub-pixels disposed in the sensing area emit black.

According to yet another embodiment of the invention, a method of driving a display device including a liquid crystal display panel including an active area and a sensing area disposed within the active area and an optical module disposed under the liquid crystal display panel and including a first light source element configured to supply light to the sensing area and an optical element configured to sense external light through the sensing area, includes: driving at least one of white sub-pixels disposed in the sensing area to emit white; and driving the first light source element with lower power consumption than when all of the white sub-pixels disposed in the sensing area emit black.

The method may further include controlling the first light source element to limit power reduction such that gray levels for the red, green, or blue sub-pixels in the sensing area to achieve a target color do not exceed a maximum gray level of 255.

It is to be understood that both the foregoing general description and the following detailed description are exemplary and explanatory and are intended to provide further explanation of the invention as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are included to provide a further understanding of the invention and are incorporated in and constitute a part of this specification, illustrate embodiments of the invention, and together with the description serve to explain the inventive concepts.

FIG. 1 is a view schematically showing a display device according to an embodiment of the invention.

FIG. 2 is a view showing cross-sections taken along lines I–I’ and II–II’ in FIG. 1, respectively.

FIG. 3 is a view showing an equivalent circuit of a sub-pixel area disposed within a liquid crystal display panel in the display device according to an embodiment of the invention.

FIG. 4 is a cross-sectional view of one sub-pixel area in an active area excluding a sensing area.

FIG. 5 is a view showing arrangement of sub-pixels in the active area and the sensing area of the liquid crystal display panel according to an embodiment of the invention.

FIG. 6 is a view showing an example of a cross-section taken along line A1-A1’ in FIG. 5.

FIG. 7 is a view showing an example of a cross-section taken along line A2-A2’ in FIG. 5.

FIG. 8 is a graph showing a change in luminance according to a current applied to a module light source element of the display device according to an embodiment of the invention.

FIG. 9 is a table showing luminance according to a current applied to the module light source element and a change in luminance according to a change in current in the display device according to an embodiment of the invention.

FIG. 10 is a view illustrating target luminance of the sensing area when white sub-pixels of second unit pixels in the sensing area are driven to emit black and the module light source element is driven at predetermined power consumption in the display device according to an embodiment of the invention.

FIG. 11 is a view illustrating luminance of the sensing area when one ninth of the white sub-pixels of the second unit pixels in the sensing area are driven to emit white and the module light source element is driven at predetermined power consumption in the display device according to an embodiment of the invention.

FIG. 12 is a view illustrating luminance of the sensing area when one ninth of the white sub-pixels of the second unit pixels in the sensing area are driven to emit white and the module light source element is driven at low power consumption in the display device according to an embodiment of the invention.

FIG. 13A, FIG. 13B, and FIG. 13C are views illustrating a driving method capable of reducing power consumption in the display device according to an embodiment of the invention.

FIG. 14A, FIG. 14B, FIG. 14C, FIG. 14D, and FIG. 14E are views illustrating a driving method capable of reducing power consumption in the display device according to another embodiment of the invention.

FIG. 15A, FIG. 15B, FIG. 15C, and FIG. 15D are views illustrating a driving method capable of reducing power consumption in the display device according to still another embodiment of the invention.

FIG. 16A, FIG. 16B, FIG. 16C, and FIG. 16D are views illustrating a driving method capable of reducing power consumption in the display device according to still another embodiment of the invention.

FIG. 17A, FIG. 17B, FIG. 17C, and FIG. 17D are views illustrating a driving method capable of reducing power consumption in the display device according to still another embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

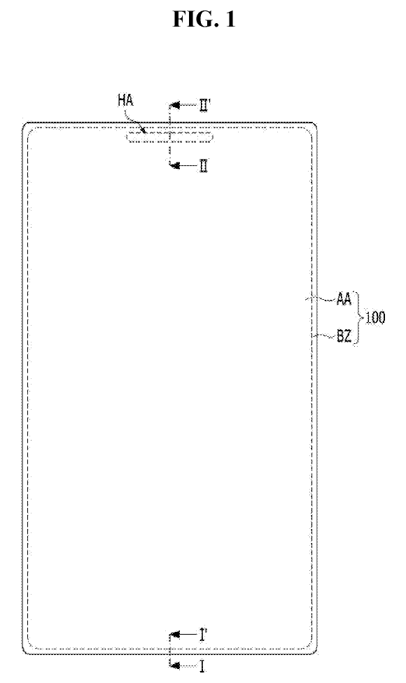

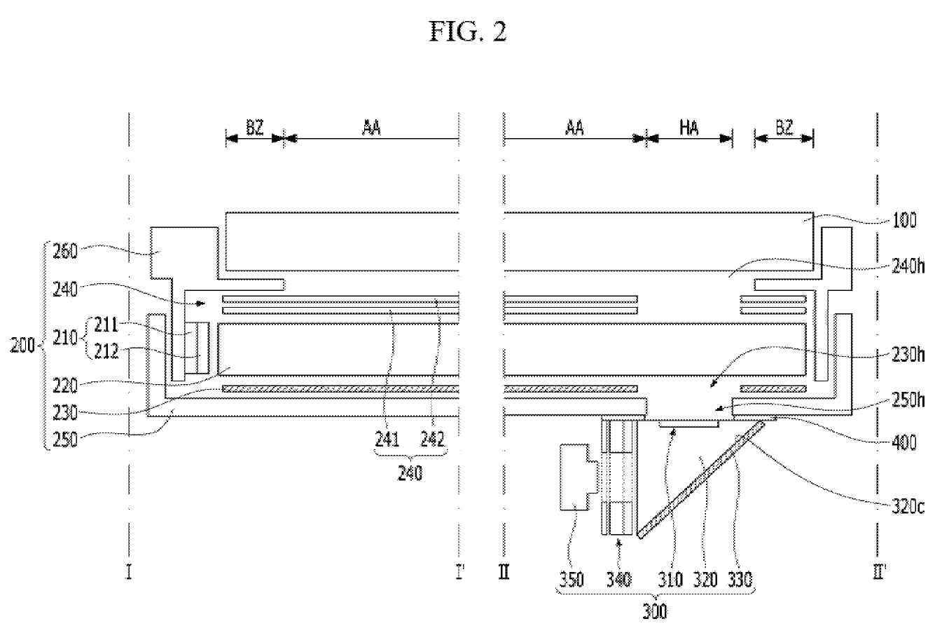

FIG. 1 is a view schematically showing a display device according to an embodiment of the invention, and FIG. 2 is a view showing cross-sections taken along lines I–I’ and II–II’ in FIG. 1, respectively.

As shown in FIGS. 1 and 2, the display device according to an embodiment of the invention may include a liquid crystal display panel 100, a backlight unit 200, and an optical module 300.

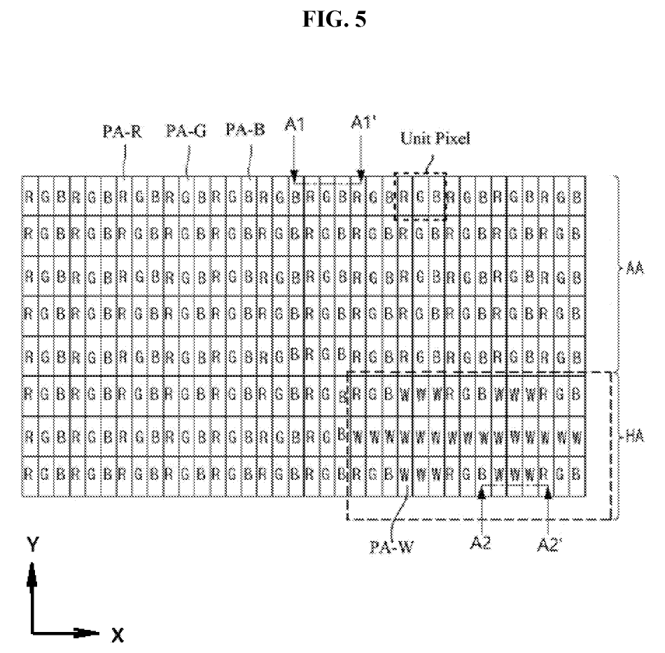

The liquid crystal display panel 100 may display an image provided to a user. For example, the liquid crystal display panel 100 may include an active area AA in which a plurality of sub-pixel areas PA (referring to FIG. 4) is disposed and a bezel area BZ disposed outside the active area AA.

The liquid crystal display panel 100 may include a liquid crystal layer LC (referring to FIG. 4) overlapping the sub-pixel areas. For example, the liquid crystal layer of the liquid crystal display panel 100 may include liquid crystals of an in-plane switching (IPS) mode, a fringe field switching (FFS) mode, or a twisted nematic (TN) mode. Various signals may be applied to each sub-pixel area through signal lines. For example, liquid crystals located in a portion of the liquid crystal layer overlapping each sub-pixel area may be rotated by a vertical electric field or a horizontal electric field formed in the corresponding sub-pixel area through the signal lines. Accordingly, in the display device according to an embodiment of the invention, images of various colors may be displayed by light emitted from the active area AA of the liquid crystal display panel 100.

The liquid crystal display panel 100 may include a sensing area HA disposed within the active area AA, for sensing external light or capturing an image. The sensing area HA of the liquid crystal display panel 100 may overlap the optical module 300 disposed under the liquid crystal display panel 100. A transmittance of the sensing area HA of the liquid crystal display panel 100 may be higher than a transmittance of the active area AA in order to maximize external-light sensing of the optical module 300. For example, in the active area AA, R, G, and B sub-pixels for displaying the red, green, and blue colors, respectively, may be disposed. In the sensing area HA, in addition to the R, G, and B sub-pixels, white sub-pixels W for displaying the white colors, in which the color filter may not be disposed, may be further disposed. This will be described later in detail with reference to FIG. 5 and subsequent drawings.

The backlight unit 200 may be disposed under the liquid crystal display panel 100, and may be disposed between the liquid crystal display panel 100 and the optical module 300. The backlight unit 200 may supply light to the liquid crystal display panel 100. For example, the liquid crystal display panel 100 may generate an image provided to a user by using light supplied from the backlight unit 200. For example, the backlight unit 200 may include a backlight light source element 210, a backlight light guide plate 220, a backlight reflector 230, and a backlight sheet 240.

The backlight light source element 210 may supply light to the liquid crystal display panel 100 through the backlight light guide plate 220. For example, the backlight unit 200 may be configured to supply light to the active area AA of the liquid crystal display panel 100 through the backlight light guide plate 220. For example, the backlight light source element 210 may be disposed on one side surface of the backlight light guide plate 220. The liquid crystal display panel 100 may be disposed above an upper surface of the backlight light guide plate 220. The backlight light source element 210 may include a backlight circuit board 211 and a backlight light source 212 mounted on the backlight circuit board 211. The backlight light source 212 may be a self-emissive element capable of generating and emitting light. For example, the backlight light source 212 may include a plurality of LEDs.

The backlight reflector 230 may be disposed on a lower surface of the backlight light guide plate 220. The lower surface of the backlight light guide plate 220 may be opposite the upper surface of the backlight light guide plate 220. For example, the backlight light guide plate 220 may be disposed between the backlight reflector 230 and the liquid crystal display panel 100. The backlight reflector 230 may include a material capable of reflecting light. For example, the backlight reflector 230 may include metal, such as aluminum (Al) or silver (Ag). Accordingly, in the display device according to an embodiment of the invention, light emitted through the lower surface of the backlight light guide plate 220 may be reflected toward the liquid crystal display panel 100 by the backlight reflector 230. Therefore, in the display device according to an embodiment of the invention, an amount of light supplied to the liquid crystal display panel 100 by the backlight unit 200 may be increased.

The backlight sheet 240 may be disposed between the backlight light guide plate 220 and the liquid crystal display panel 100. Light supplied to the liquid crystal display panel 100 through the backlight light guide plate 220 may have overall uniform luminance due to the backlight sheet 240. For example, the backlight sheet 240 may have a stacked structure of a prism sheet 241 and a diffusion sheet 242.

The backlight unit 200 may further include a cover bottom 250 to accommodate the backlight light source element 210, the backlight light guide plate 220, the backlight reflector 230, and the backlight sheet 240. The cover bottom 250 may include an insulating material. For example, the cover bottom 250 may include plastic. The cover bottom 250 may include a bottom surface and a sidewall protruding from an edge of the bottom surface. The backlight reflector 230 may be disposed between the backlight light guide plate 220 and the bottom surface of the cover bottom 250. The backlight light source element 210, the backlight light guide plate 220, and the backlight sheet 240 may be disposed in a space defined by the sidewall of the cover bottom 250. For example, the sidewall of the cover bottom 250 may surround the backlight light source element 210, the backlight light guide plate 220, and the backlight sheet 240.

The backlight unit 200 may further include a middle frame 260 to support the liquid crystal display panel 100. The middle frame 260 may be coupled to the cover bottom 250. For example, the middle frame 260 may include a coupling area extending between the sidewall of the cover bottom 250 and the side surface of the backlight light guide plate 220. The backlight light source element 210 may be fixed to the coupling area of the middle frame 260. For example, the backlight light source element 210 may be attached to the coupling area of the middle frame 260 using an adhesive member. The middle frame 260 may include a seating area extending between the backlight sheet 240 and the liquid crystal display panel 100. The seating area of the middle frame 260 may overlap an edge of the backlight sheet 240. For example, the seating area of the middle frame 260 may overlap the bezel area BZ of the liquid crystal display panel 100. The active area AA of the liquid crystal display panel 100 may not overlap the seating area of the middle frame 260. For example, a central area of the backlight sheet 240 may be exposed by the middle frame 260. The seating area of the middle frame 260 may be in direct contact with the backlight sheet 240. Accordingly, in the display device according to an embodiment of the invention, movement of the backlight sheet 240 may be prevented by the middle frame 260.

The optical module 300 may sense external light through the liquid crystal display panel 100 and the backlight unit 200. For example, the optical module 300 may be disposed on the cover bottom 250 of the backlight unit 200. The liquid crystal display panel 100 may include a sensing area HA to sense external light. The sensing area HA may be disposed within the active area AA. For example, the backlight reflector 230 may include a through-hole 230h overlapping the sensing area HA of the liquid crystal display panel 100, the backlight sheet 240 may include a sheet hole 240h overlapping the sensing area HA of the liquid crystal display panel 100, and the cover bottom 250 may include a cover hole 250h overlapping the sensing area HA of the liquid crystal display panel 100.

The optical module 300 may include a module light source element 350, a module light guide plate 320, a module reflector 330, a module sheet 340, and an optical element 310.

The module light source element 350 may be configured to supply light to the sensing area AA. The module light source element 350 may be disposed on the side surface of the module light guide plate 320, with the module sheet 340 interposed between the module light source element 350 and the side surface of the module light guide plate 320. The module light guide plate 320 may overlap the sensing area HA of the liquid crystal display panel 100. The side surfaces of the module light guide plate 320 on which the module light source element 350 is disposed may be perpendicular to an upper surface of the module light guide plate 320 facing the backlight light guide plate 220. The module light guide plate 320 may include an inclined surface 320c overlapping the sensing area HA of the liquid crystal display panel 100. For example, the module light source element 350 may be disposed on the side surface which is perpendicular to the upper surface and is opposite to the inclined surface 320c of the module light guide plate 320. Accordingly, in the display device according to an embodiment of the invention, light emitted from the module light source element 350 may be supplied to the sensing area HA of the liquid crystal display panel 100 by the inclined surface 320c and through the upper surface of the module light guide plate 320.

The module light source element 350 may include a module circuit board and module light sources. For example, the configuration of the module light source element 350 may be identical to that of the backlight light source element 210. The module light sources may be self-emissive elements capable of generating and emitting light. For example, the module light source element 350 may include a plurality of LEDs. For example, the configuration of the module light source element 350 may be identical to that of the backlight light source 212. The module light source may be mounted on one end portion of the module circuit board. The module light source element 350 may be driven simultaneously with the backlight light source element 210. For example, in the display device according to an embodiment of the invention, the liquid crystal display panel 100 may display an image using light emitted from the backlight light source element 210 and light emitted from the module light source element 350. That is, in the display device according to an embodiment of the invention, when the liquid crystal display panel 100 displays an image, light may be supplied to the sensing area HA of the liquid crystal display panel 100 by the module light source element 350. Accordingly, in the display device according to an embodiment of the invention, when the liquid crystal display panel 100 displays an image, light supplied to the sensing area HA may have substantially the same luminance as light supplied to the active area AA. Therefore, in the display device according to an embodiment of the invention, degradation in image quality due to a luminance deviation between the active area AA and the sensing area HA may be prevented.

The module reflector 330 may be disposed on the inclined surface 320c of the module light guide plate 320. The module reflector 330 may include a material capable of reflecting light. For example, the module reflector 330 may include a metal such as aluminum (Al) or silver (Ag). The module reflector 330 may include the same material as the backlight reflector 230. Accordingly, in the display device according to an embodiment of the invention, light emitted through the inclined surface 320c of the module light guide plate 320 may be reflected in the inward direction of the module light guide plate 320 by the module reflector 330. Therefore, in the display device according to an embodiment of the invention, an amount of light supplied to the sensing area HA of the liquid crystal display panel 100 through the module light guide plate 320 may be increased.

The module sheet 340 may be disposed on a side surface of the module light guide plate 320 that is opposite to the inclined surface 320c. For example, the module sheet 340 may be attached to the module light guide plate 320. The module light source element 350 may be disposed on the module sheet 340. That is, the module sheet 340 may be disposed between the module light guide plate 320 and the optical element 310. For example, in the display device according to an embodiment of the invention, external light introduced into the module light guide plate 320 through the sensing area HA of the liquid crystal display panel 100 and the backlight light guide plate 220 may be supplied to the optical element 310 through the module sheet 340.

The external light introduced through the sensing area HA of the liquid crystal display panel 100 may pass through the sheet hole 240h in the backlight sheet 240. Accordingly, in the display device according to an embodiment of the invention, the external light supplied to the optical element 310 may not be refracted and/or diffused by the backlight sheet 240. That is, in the display device according to an embodiment of the invention, external light may be sensed by the optical element 310 without distortion caused by the backlight sheet 240. Therefore, in the display device according to an embodiment of the invention, external-light sensing characteristics may be improved.

The optical element 310 may be configured to sense external light through the sensing area. The optical element 310 may include an element capable of sensing external light. For example, the optical element 310 may include a camera and an IR sensor. The backlight sheet 240 may include a first hole corresponding to the camera and a second hole corresponding to the IR sensor. Accordingly, in the display device according to an embodiment of the invention, external light passing through the first hole in the backlight sheet 240 may be provided to the camera, and external light passing through the second hole in the backlight sheet 240 may be provided to the IR sensor.

The optical module 300 may be fixed on the backlight unit 200. For example, a fixing tape 400 may be disposed between the cover bottom 250 and the optical module 300. The fixing tape 400 may be in direct contact with the cover bottom 250 and the optical module 300. For example, the optical module 300 may be attached to the cover bottom 250 by means of the fixing tape 400. Accordingly, in the display device according to an embodiment of the invention, movement of the optical module 300 may be prevented. Therefore, in the display device according to an embodiment of the invention, external-light sensing characteristics by the optical element 310 of the optical module 300 may be improved.

As a result, the display device according to an embodiment of the invention may include the liquid crystal display panel 100 disposed on the upper surface of the backlight light guide plate 220 and the optical module 300 disposed on the lower surface of the backlight light guide plate 220. Furthermore, the liquid crystal display panel 100 may include the sensing area HA to sense external light, and the optical module 300 may include the module light guide plate 320 overlapping the sensing area HA, the module light source element 350 disposed on the side surfaces of the module light guide plate 320 opposite to the inclined surface 320c, and the optical element 310 disposed on the upper surface of the module light guide plate 320 opposite to the inclined surface 320c. Accordingly, in the display device according to an embodiment of the invention, when the liquid crystal display panel 100 displays an image, light supplied to the sensing area HA of the liquid crystal display panel 100 by the module light source element 350 that is driven simultaneously (e.g., being turned on and off simultaneously) with the backlight light source element 210 may have the same luminance as light supplied to the active area AA of the liquid crystal display panel 100 by the backlight light source element 210. In addition, in the display device according to an embodiment of the invention, when the liquid crystal display panel 100 does not generate an image, external light introduced through the sensing area HA of the liquid crystal display panel 100, the backlight light guide plate 220, and the cover bottom 250 may be sensed by the optical element 310. Therefore, in the display device according to an embodiment of the invention, external light may be sensed without degradation in image quality.

In the display device according to an embodiment of the invention, the optical element 310 is described as including the camera and the IR sensor. However, in a display device according to another embodiment of the invention, the optical element 310 may include various elements. For example, in the display device according to another embodiment of the invention, the optical element 310 may include, in addition to the camera and the IR sensor, one or more of a motion sensor, an illuminance sensor, or an ultrasonic sensor.

In the display device according to an embodiment of the invention, the configuration of the module light source of the module light source element 350 is described as being identical to that of the backlight light source 212. However, in a display device according to another embodiment of the invention, the type and number of module light sources may be determined according to luminance of light supplied to the active area AA of the liquid crystal display panel 100 by the backlight light source 212. In addition, in the display device according to another embodiment of the invention, the type and number of module light sources may be determined according to an area ratio between the active area AA and the sensing area HA of the liquid crystal display panel 100. That is, in the display device according to another embodiment of the invention, the type and number of module light sources may be adjusted such that luminance of light supplied to the sensing area HA of the liquid crystal display panel 100 is substantially identical to luminance of light supplied to the active area AA of the liquid crystal display panel 100 when the liquid crystal display panel 100 displays an image. Accordingly, in the display device according to another embodiment of the invention, degradation in image quality due to a luminance deviation between the active area AA and the sensing area HA of the liquid crystal display panel 100 may be effectively prevented.

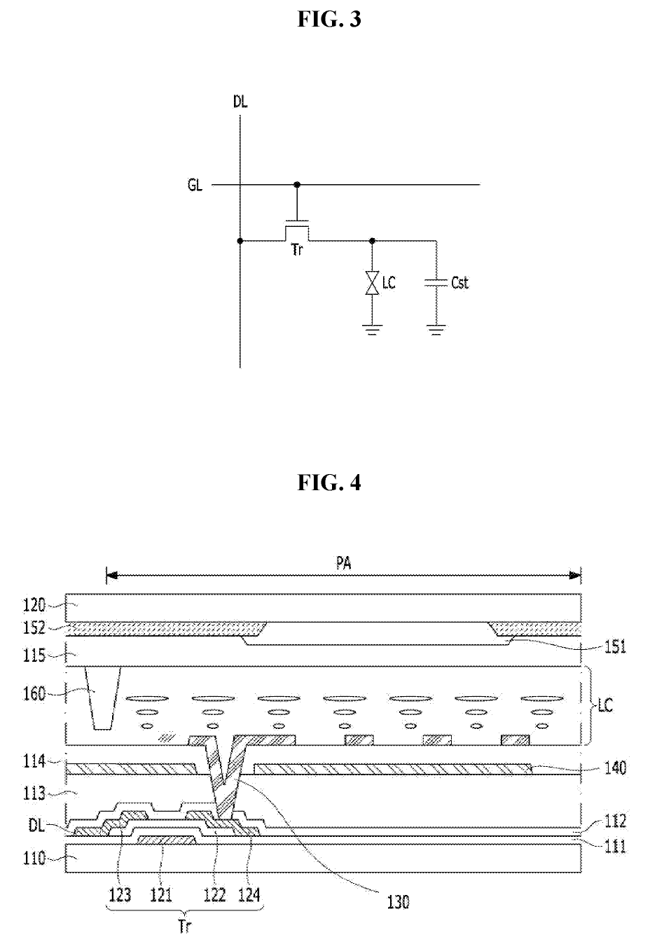

FIG. 3 is a view showing an equivalent circuit of a sub-pixel area disposed within the liquid crystal display panel in the display device according to an embodiment of the invention. FIG. 4 is a cross-sectional view of one sub-pixel area PA in the active area AA excluding the sensing area.

As shown in FIG. 3, each sub-pixel area PA of the liquid crystal display panel 100 may include at least one thin-film transistor Tr and a storage capacitor Cst. Various signals may be applied to each sub-pixel area PA through signal lines (e.g., GL and DL in FIG. 3). For example, the signal lines GL and DL may include gate lines GL for sequentially applying gate signals and data lines DL for applying data signals. The gate lines GL may intersect the data lines DL. For example, the gate lines GL may extend in a first direction, and the data lines DL may extend in a second direction perpendicular to the first direction. The data lines DL may be disposed on a layer different from a layer on which the gate lines GL are disposed.

As shown in FIG. 4, the liquid crystal display panel 100 may include a liquid crystal layer LC disposed between a first display substrate 110 and a second display substrate 120. The first display substrate 110 and the second display substrate 120 may include an insulating material. The first display substrate 110 and the second display substrate 120 may include a transparent material. For example, the first display substrate 110 and the second display substrate 120 may include glass or plastic. The second display substrate 120 may include a material different from a material of the first display substrate 110. The liquid crystal layer LC may include liquid crystals of various modes. For example, the liquid crystal layer LC may include liquid crystals operating in an IPS mode. Liquid crystals of the liquid crystal layer LC overlapping each sub-pixel area PA may be rotated by a vertical electric field or a horizontal electric field formed in the corresponding sub-pixel area PA according to the gate signal and the data signal. For example, a pixel electrode 130 for forming a horizontal electric field and a common electrode 140 overlapping a portion of the pixel electrode 130 may be disposed in each sub-pixel area PA.

A constant power supply voltage may be supplied to the common electrode 140 in each sub-pixel area PA. A driving voltage corresponding to a data signal applied to a corresponding sub-pixel area PA may be supplied to the pixel electrode 130 in each sub-pixel area PA according to a gate signal applied to the corresponding sub-pixel area PA. That is, in the display device according to an embodiment of the invention, a vertical electric field or a horizontal electric field may be formed in each sub-pixel area PA by the driving voltage applied to the pixel electrode 130 in the corresponding sub-pixel area PA and the power supply voltage applied to the common electrode 140. The driving voltage applied to the pixel electrode 130 in each sub-pixel area PA may be maintained for one frame. For example, at least one thin-film transistor Tr and a storage capacitor Cst may be disposed in each sub-pixel area PA.

The thin-film transistor Tr in each sub-pixel area PA may generate a driving voltage corresponding to a data signal applied to the corresponding sub-pixel area PA according to a gate signal applied to the corresponding sub-pixel area PA. The thin-film transistor Tr in each sub-pixel area PA may be electrically connected to one of the gate lines GL and one of the data lines DL. For example, the thin-film transistor Tr in each sub-pixel area PA may include a gate electrode 121 electrically connected to one of the gate lines GL, a semiconductor pattern 122 including a region overlapping the gate electrode 121, a drain electrode 123 electrically connected to one end portion of the semiconductor pattern 122, and a source electrode 124 electrically connected to the other end portion of the semiconductor pattern 122.

The gate electrode 121 may include a conductive material. For example, the gate electrode 121 may include a metal, such as aluminum (Al), chromium (Cr), copper (Cu), molybdenum (Mo), titanium (Ti), or tungsten (W). The semiconductor pattern 122 may be disposed on the gate electrode 121. The semiconductor pattern 122 may include a semiconductor material. For example, the semiconductor pattern 122 may include amorphous silicon (a-Si), polycrystalline silicon (poly-Si), or an oxide semiconductor such as IGZO. The semiconductor pattern 122 may include a channel region disposed between a drain region and a source region. For example, the gate electrode 121 may overlap the channel region of the semiconductor pattern 122. The drain region and the source region of the semiconductor pattern 122 may be disposed outside the gate electrode 121.

The drain region and the source region of the semiconductor pattern 122 may have lower resistance than the channel region of the semiconductor pattern 122. For example, the drain region and the source region of the semiconductor pattern 122 may include conductivized regions of an oxide semiconductor. The channel region of the semiconductor pattern 122 may be a non-conductivized region of an oxide semiconductor. The semiconductor pattern 122 may be spaced apart from the gate electrode 121. The semiconductor pattern 122 may be insulated from the gate electrode 121. For example, the channel region of the semiconductor pattern 122 may have electrical conductivity corresponding to a voltage supplied to the gate electrode 121. The drain region of the semiconductor pattern 122 may be electrically connected to the source region of the semiconductor pattern 122 according to a signal applied to the gate electrode 121.

The drain electrode 123 and the source electrode 124 may include a conductive material. For example, the drain electrode 123 and the source electrode 124 may include a metal, such as aluminum (Al), chromium (Cr), copper (Cu), molybdenum (Mo), titanium (Ti), or tungsten (W). The drain electrode 123 and the source electrode 124 may include a material different from a material of the gate electrode 121. For example, the drain electrode 123 and the source electrode 124 may be disposed on a layer different from a layer on which the gate electrode 121 is disposed. The source electrode 124 may be disposed on the same layer as the drain electrode 123. The source electrode 124 may include the same material as the drain electrode 123. The source electrode 124 may be formed through the same process as the drain electrode 123. For example, the source electrode 124 may be formed simultaneously with the drain electrode 123.

The drain electrode 123 may be electrically connected to the drain region of the semiconductor pattern 122. The source electrode 124 may be electrically connected to the source region of the semiconductor pattern 122. The drain electrode 123 and the source electrode 124 may be insulated from the gate electrode 121. The source electrode 124 may be spaced apart from the drain electrode 123. For example, the drain electrode 123 in each sub-pixel area PA may be electrically connected to one of the data lines DL. The drain electrode 123 may be integrally formed with one of the data lines DL. The pixel electrode 130 in each sub-pixel area PA may be electrically connected to the source electrode 124 in the corresponding sub-pixel area PA.

The storage capacitor Cst in each sub-pixel area PA may maintain, for one frame, a signal applied to the gate electrode 121 in the corresponding sub-pixel area PA. For example, the storage capacitor Cst in each sub-pixel area PA may be electrically connected to the gate electrode 121 in the corresponding sub-pixel area PA and to a power supply voltage supply line supplying the power supply voltage.

The thin-film transistor Tr and the storage capacitor Cst in each sub-pixel area PA may be disposed between the first display substrate 110 and the liquid crystal layer LC. A plurality of insulating layers 111, 112, 113, and 114 may be disposed between the first display substrate 110 and the liquid crystal layer LC in order to prevent unnecessary electrical connections. For example, a gate insulating layer 111, a device protection layer 112, a planarization layer 113, and an interlayer insulating layer 114 may be disposed between the first display substrate 110 and the liquid crystal layer LC.

The gate insulating layer 111 may be disposed close to the first display substrate 110. The semiconductor pattern 122 in each sub-pixel area PA may be insulated from the gate electrode 121 in the corresponding sub-pixel area PA by the gate insulating layer 111. For example, the gate insulating layer 111 may cover the gate electrode 121 in each sub-pixel area PA. The semiconductor pattern 122 in each sub-pixel area PA may be disposed on the gate insulating layer 111. The drain electrode 123 and the source electrode 124 in each sub-pixel area PA may be in direct contact with portions of the semiconductor pattern 122 disposed in the corresponding sub-pixel area PA. For example, the drain electrode 123 and the source electrode 124 in each sub-pixel area PA may be disposed on the gate insulating layer 111. The gate insulating layer 111 may include an insulating material. For example, the gate insulating layer 111 may include an inorganic insulating material, such as silicon oxide (SiOₓ) or silicon nitride (SiNₓ).

The device protection layer 112 may be disposed on the gate insulating layer 111. The device protection layer 112 may prevent damage to the thin-film transistor Tr disposed in each sub-pixel area PA due to external impact or moisture. For example, the semiconductor pattern 122, the drain electrode 123, and the source electrode 124 in each sub-pixel area PA may be covered by the device protection layer 112. The device protection layer 112 may include an insulating material. For example, the device protection layer 112 may include an inorganic insulating material, such as silicon oxide (SiOₓ) or silicon nitride (SiNₓ).

The planarization layer 113 may be disposed on the device protection layer 112. The planarization layer 113 may remove a step caused by the thin-film transistor Tr and the storage capacitor Cst in each sub-pixel area PA. For example, an upper surface of the planarization layer 113 facing the liquid crystal layer LC may be parallel to an upper surface of the first display substrate 110 facing the liquid crystal layer LC. The planarization layer 113 may include an insulating material. The planarization layer 113 may include a material different from a material of the device protection layer 112. The planarization layer 113 may include a material having relatively high fluidity. For example, the planarization layer 113 may include an organic insulating material.

The common electrode 140 may be disposed on the planarization layer 113. The interlayer insulating layer 114 may be disposed between the planarization layer 113 and the liquid crystal layer LC. The common electrode 140 in each sub-pixel area PA may be insulated from the pixel electrode 130 in the corresponding sub-pixel area PA by the interlayer insulating layer 114. For example, the interlayer insulating layer 114 may cover the common electrode 140 in each sub-pixel area PA. The pixel electrode 130 in each sub-pixel area PA may be disposed between the interlayer insulating layer 114 and the liquid crystal layer LC. Each pixel electrode 130 may include at least one slit. The interlayer insulating layer 114 may include an insulating material. For example, the interlayer insulating layer 114 may include an inorganic insulating material.

The position of the common electrode 140 and the position of the pixel electrode 130 may be opposite those exemplified above. For example, the pixel electrode 130 may be disposed on the planarization layer 113, and the common electrode 140 may be disposed on the interlayer insulating layer 114.

Color filters 151, a black matrix 152, and an upper protection layer 115 may be disposed between the liquid crystal layer LC and the second display substrate 120. The color filters 151 may overlap the sub-pixel areas PA. For example, each color filter 151 may overlap a respective one of the sub-pixel areas PA. Each color filter 151 may display a specific color using light passing through the liquid crystal layer LC. For example, light having passed through each color filter 151 may display one of red, blue, and green. The black matrix 152 may be disposed alongside the color filters 151. For example, an end portion of each color filter 151 may overlap the black matrix 152. Although FIG. 4 illustrates a configuration in which an end portion of each color filter 151 overlaps the black matrix 152 and end portions of two adjacent color filters 151 do not overlap each other on the black matrix 152, the inventive concepts are not limited thereto. End portions of two adjacent color filters 151 may overlap each other on the black matrix 152.

The black matrix 152 may include a material capable of reflecting or absorbing light. For example, light having passed through the liquid crystal layer LC in each sub-pixel area PA may be emitted to the outside through the color filter 151 in the corresponding sub-pixel area PA disposed in a region defined by the black matrix 152. Accordingly, in the display device according to an embodiment of the invention, an image including various colors may be provided to a user.

The black matrix 152 may overlap the signal lines GL and DL. The thin-film transistor Tr and the storage capacitor Cst in each sub-pixel area PA may overlap the black matrix 152. Accordingly, in the display device according to an embodiment of the invention, the signal lines GL and DL and the thin-film transistor Tr and the storage capacitor Cst in each sub-pixel area PA may not be recognized by a user due to the black matrix 152. That is, in the display device according to an embodiment of the invention, degradation in image quality, which may be recognized by a user due to the signal lines GL and DL and the thin-film transistor Tr and the storage capacitor Cst in each sub-pixel area PA, may be prevented. The color filters 151 and the black matrix 152 may be covered by the upper protection layer 115. The upper protection layer 115 may prevent damage to the color filters 151 and the black matrix 152 due to external impact or moisture. The upper protection layer 115 may include an insulating material. For example, the upper protection layer 115 may include an inorganic insulating material, such as silicon oxide (SiOₓ) or silicon nitride (SiNₓ).

A spacer 160 may be disposed between the interlayer insulating layer 114 and the upper protection layer 115. The spacer 160 may maintain a constant distance between the interlayer insulating layer 114 and the upper protection layer 115. Accordingly, in the display device according to an embodiment of the invention, the liquid crystal layer LC in each sub-pixel area PA may have the same thickness. Therefore, in the display device according to an embodiment of the invention, light passing through the liquid crystal layer LC in each sub-pixel area PA may have the same optical path. In addition, in the display device according to an embodiment of the invention, light passing through the liquid crystal layer LC in each sub-pixel area PA may have the same luminance as light passing through the liquid crystal layer LC in a sub-pixel area PA in which a horizontal electric field identical to a horizontal electric field formed in the corresponding sub-pixel area PA is formed.

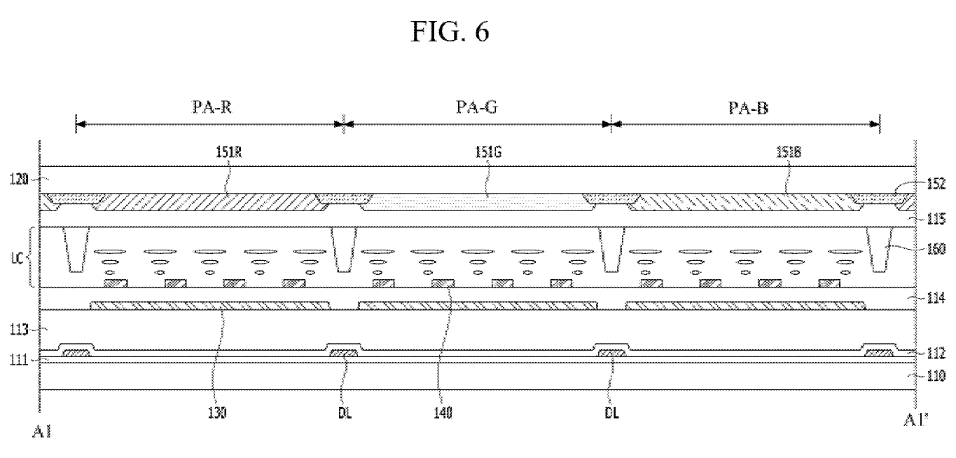

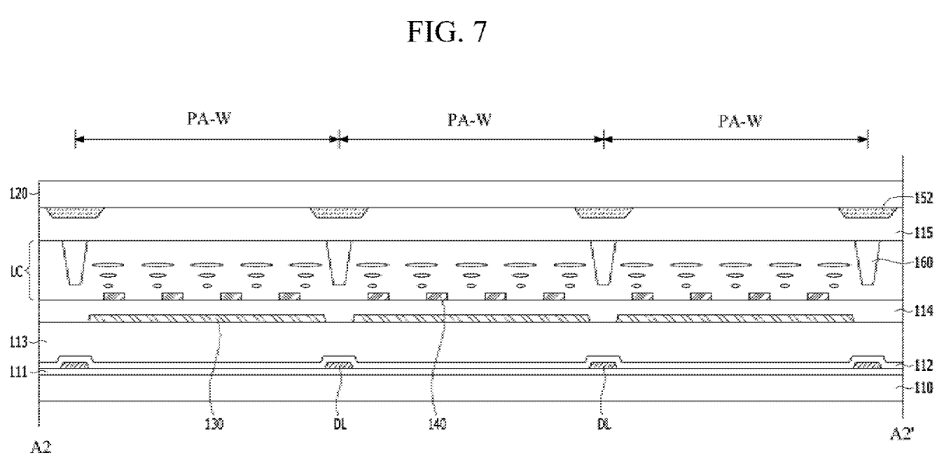

FIG. 5 is a view showing arrangement of sub-pixels in the active area AA and the sensing area HA of the liquid crystal display panel according to an embodiment of the invention. FIG. 6 is a view showing an example of a cross-section taken along line A1-A1’ in FIG. 5, and FIG. 7 is a view showing an example of a cross-section taken along line A2-A2’ in FIG. 5.

As shown in FIGS. 5 -7, the plurality of sub-pixels may include a red sub-pixel PA-R emitting red R, a green sub-pixel PA-G emitting green G, a blue sub-pixel PA-B emitting blue B, and a white sub-pixel PA-W emitting white W.

As shown in FIG. 5, in each of the active area AA and the sensing area HA, the plurality of sub-pixels may have the same width and length. That is, the sub-pixels PA disposed in the active area AA of the liquid crystal display panel 100 and the sub-pixels PA disposed in the sensing area HA of the liquid crystal display panel 100 may have the same width and length. The sub-pixels disposed in the sensing area HA may be arranged in a line in the same direction as the sub-pixels disposed in the active area AA. One unit pixel may include a red sub-pixel PA-R, a green sub-pixel PA-G, and a blue sub-pixel PA-B, which are disposed adjacent to each other in a Y-axis direction.

The active area AA may not include a white sub-pixel PA-W, and the sub-pixels provided in the sensing area HA may include at least one white sub-pixel PA-W.

The sensing area HA may include first unit pixels, each including a red sub-pixel PA-R, a green sub-pixel PA-G, and a blue sub-pixel PA-B, and second unit pixels, each including three white sub-pixels PA-W. For example, the first unit pixels may account for one fourth of the number of unit pixels disposed in the sensing area HA, and the second unit pixels may account for three fourths of the number of unit pixels disposed in the sensing area HA. The white sub-pixels PA-W provided in the sensing area HA may not include color filters.

For example, as shown in FIG. 6, when the active area AA is viewed in cross section, each sub-pixel may include a color filter. In detail, the red sub-pixel PA-R may include a red color filter 151R, the green sub-pixel PA-G may include a green color filter 151G, and the blue sub-pixel PA-B may include a blue color filter 151B. However, as shown in FIG. 7, the white sub-pixels PA-W in the sensing area HA may not include color filters.

In addition, in the sensing area HA, the R, G, and B sub-pixels of the first unit pixels may include color filters, whereas, as shown in FIG. 7, the white sub-pixels PA-W of the second unit pixels may not include color filters. Accordingly, transmittance by the liquid crystal display panel 100 in the sensing area HA may be higher than transmittance by the liquid crystal display panel 100 in the active area AA. Therefore, in the display device according to an embodiment of the invention, external-light sensing capability of the optical module may be further improved.

The cross-sectional structures shown in FIGS. 6 and 7 may have the same configuration as the structure described with reference to FIG. 4. Accordingly, descriptions of the remaining components will be omitted. However, the structure shown in FIG. 4 is configured such that the common electrode 140 is disposed on the planarization layer 113, and the pixel electrode 130 is disposed on the interlayer insulating layer 114. In contrast, the structures shown in FIGS. 6 and 7 are configured such that the pixel electrode 130 is disposed on the planarization layer 113, and the common electrode 140 is disposed on the interlayer insulating layer 114.

The position of the common electrode 140 and the position of the pixel electrode 130 in the embodiments shown in FIGS. 6 and 7 may be opposite those exemplified above. For example, the pixel electrode 130 may be disposed on the interlayer insulating layer 114, and the common electrode 140 may be disposed on the planarization layer 113.

As described above with reference to FIG. 2, the active area AA may be driven by the backlight light source element 210 of the backlight unit 200, and the sensing area HA may be driven by the module light source element 350 of the optical module 300.

As described above, in order to secure transmittance of the sensing area HA, the module light source element 350 needs to be driven. Driving the module light source element 350 requires an increase in power consumption.

In the display device of the invention, in the sensing area HA, target luminance and color may be achieved through a combination of driving of the red sub-pixels PA-R, the green sub-pixels PA-G, and the blue sub-pixels PA-B of the first unit pixels disposed in the sensing area HA and the white sub-pixels PA-W of the second unit pixels. Accordingly, an increase in power consumption caused by the module light source element 350 as described above may be lessened. This will be described in detail below.

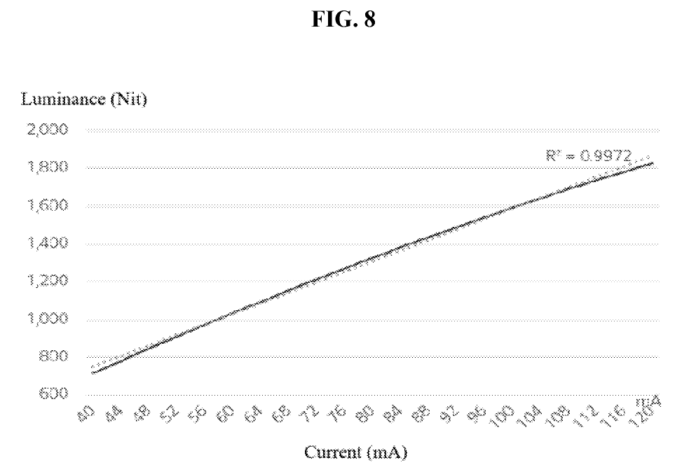

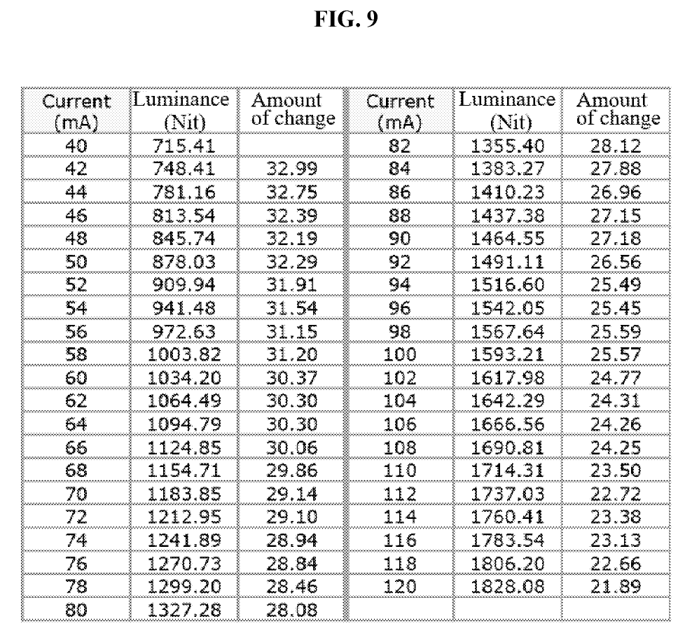

FIG. 8 is a graph showing a change in luminance according to a current applied to the module light source element of the display device according to an embodiment of the invention, and FIG. 9 is a table showing luminance according to a current applied to the module light source element and a change in luminance according to a change in current in the display device according to an embodiment of the invention.

Luminance of light emitted from the module light source element 350 was measured by adjusting a current applied to the module light source element 350. As a result, as shown in FIGS. 8 and 9, it may be seen that a relationship between the current applied to the module light source element 350 (as indicated in the horizontal axis) and luminance of light emitted from the module light source element 350 (as indicated in the vertical axis) changes in a substantial linear manner. Accordingly, a current applied to the module light source element 350 corresponding to target luminance may be calculated. In addition, in order to finely adjust luminance, the current applied to the module light source element 350 may be calculated according to target luminance, and then gray levels of the red sub-pixels PA-R, the green sub-pixels PA-G, the blue sub-pixels PA-B, and the white sub-pixels PA-W disposed in the sensing area HA may be adjusted to set a more accurate target luminance.

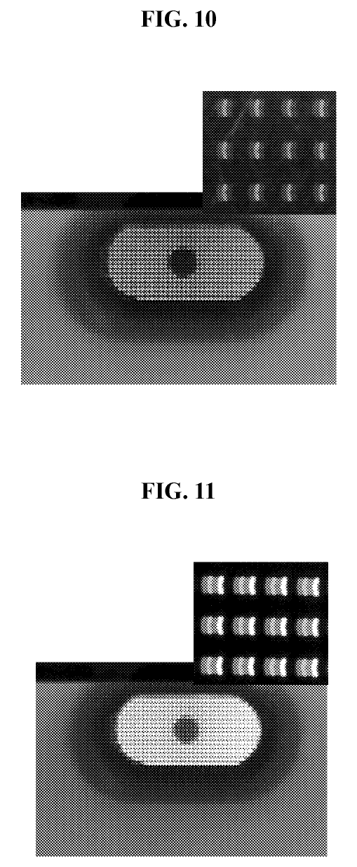

FIG. 10 is a view illustrating target luminance of the sensing area when the white sub-pixels PA-W of the second unit pixels in the sensing area are driven to emit black and the module light source element is driven at predetermined power consumption in the display device according to an embodiment of the invention.

FIG. 11 is a view illustrating luminance of the sensing area when one ninth of the white sub-pixels PA-W of the second unit pixels in the sensing area are driven to emit white and the module light source element is driven at predetermined power consumption in the display device according to an embodiment of the invention.

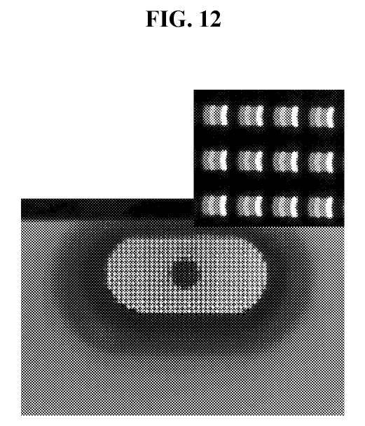

FIG. 12 is a view illustrating luminance of the sensing area when one ninth of the white sub-pixels PA-W of the second unit pixels in the sensing area are driven to emit white and the module light source element is driven at low power consumption in the display device according to an embodiment of the invention.

For example, as shown in FIG. 10, when all of the white sub-pixels PA-W in the sensing area are driven to emit black and the module light source element 350 is driven at predetermined power consumption (427.2 mW), luminance of the sensing area HA is about 100 nit.

As shown in FIG. 11, when one ninth of the white sub-pixels PA-W in the sensing area are driven to emit white and the module light source element 350 is driven at the same power consumption (427.2 mW) as in FIG. 10, luminance of the sensing area HA increases to about 265.2 nit.

As shown in FIG. 12, when one ninth of the white sub-pixels PA-W in the sensing area are driven to emit white and the module light source element 350 is driven at lower power consumption (161.0 mW) than in FIGS. 10 and 11, luminance of the sensing area HA is about 100 nit.

As described above with reference to FIGS. 10 to 12, when some of the white sub-pixels PA-W in the sensing area are driven to emit white in order to allow the sensing area to have target luminance, power consumption caused by the module light source element 350 is reduced. According to an embodiment of the invention, power consumption may be reduced, and the sensing area may be displayed with target luminance and color. In order to reduce power consumption and display the sensing area with target luminance and color, driving of the red sub-pixel PA-R, the green sub-pixel PA-G, the blue sub-pixel PA-B, and the white sub-pixel PA-W needs to be controlled.

A driving method capable of reducing power consumption of the display device including the sensing area using the principles described above with reference to FIGS. 8-12 will be described below.

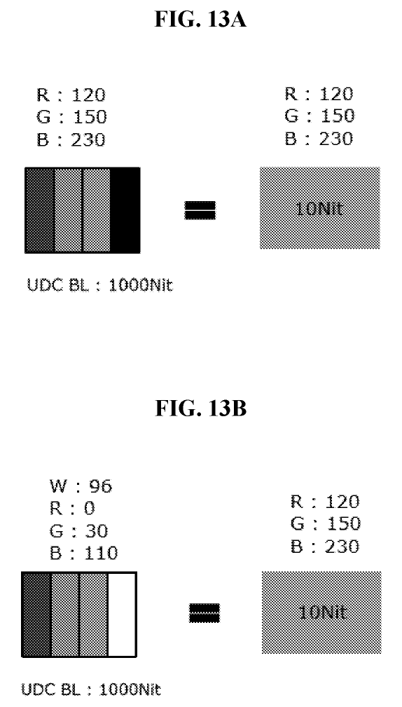

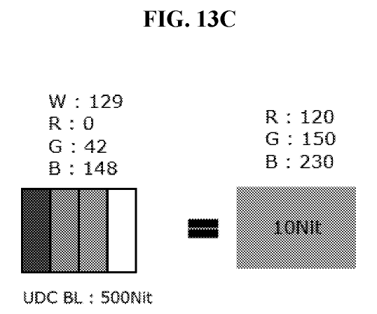

FIGS. 13A- 13C are views illustrating a driving method capable of reducing power consumption in the display device according to an embodiment of the invention.

As shown in FIG. 13A, in a state in which the red sub-pixel PA-R in the sensing area HA is driven at 120 gray, the green sub-pixel PA-G in the sensing area HA is driven at 150 gray, the blue sub-pixel PA-B in the sensing area HA is driven at 230 gray, and all of the white sub-pixels PA-W disposed in the sensing area HA of the liquid crystal display panel 100 are driven to emit black (0 gray), the module light source element 350 is required to be driven at brightness (luminance) of 1,000 nit in order to cause the sensing area HA of the liquid crystal display panel 100 to be displayed with luminance of 10 nit in a mixed color.

As shown in FIG. 13B, in a state in which the red sub-pixel PA-R in the sensing area HA is driven at 0 gray, the green sub-pixel PA-G in the sensing area HA is driven at 30 gray, the blue sub-pixel PA-B in the sensing area HA is driven at 110 gray, and one ninth of the white sub-pixels PA-W disposed in the sensing area HA of the liquid crystal display panel 100 are driven at 96 gray, the module light source element 350 is required to be driven at brightness (luminance) of 1,000 nit in order to cause the sensing area HA of the liquid crystal display panel 100 to be displayed with luminance of 10 nit in a mixed color.

As shown in FIG. 13C, in a state in which the red sub-pixel PA-R in the sensing area HA is driven at 0 gray, the green sub-pixel PA-G in the sensing area HA is driven at 42 gray, the blue sub-pixel PA-B in the sensing area HA is driven at 148 gray, and one ninth of the white sub-pixels PA-W disposed in the sensing area HA of the liquid crystal display panel 100 are driven at 129 gray, even when the module light source element 350 is driven at brightness (luminance) of 500 nit, the sensing area HA of the liquid crystal display panel 100 is displayed with luminance of 10 nit in a mixed color.

When the module light source element 350 is driven at brightness (luminance) of 1,000 nit as shown in FIGS. 13A and 13B, power consumption is 179.2 mW, whereas when the module light source element 350 is driven at brightness (luminance) of 500 nit as shown in FIG. 13C, power consumption is 82.65 mW. Power consumption in the case of FIG. 13C is reduced by about 53.9% compared with the cases of FIGS. 13A and 13B.

Accordingly, by controlling driving of the red sub-pixel PA-R, the green sub-pixel PA-G, the blue sub-pixel PA-B, and the white sub-pixel PA-W disposed in the sensing area HA, the sensing area HA may be displayed with target luminance and color while reducing power consumption caused by the module light source element 350.

In the cases of FIGS. 13A- 13C, one ninth of the white sub-pixels PA-W disposed in the sensing area HA are driven to emit white. However, even when a larger number of white sub-pixels PA-W are driven to emit white, the sensing area HA may be displayed with target luminance and color while reducing power consumption caused by the module light source element 350.

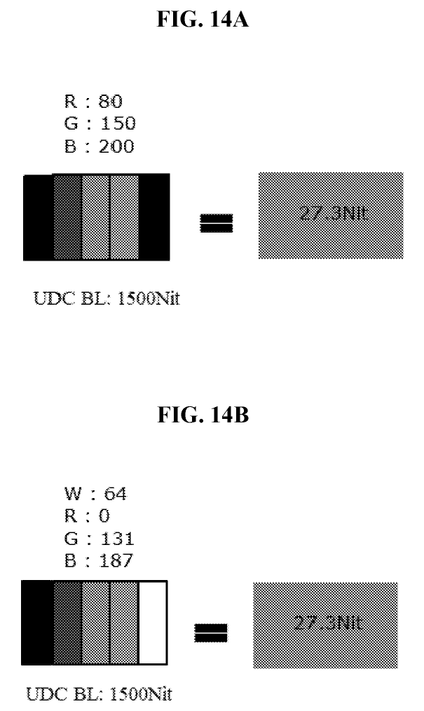

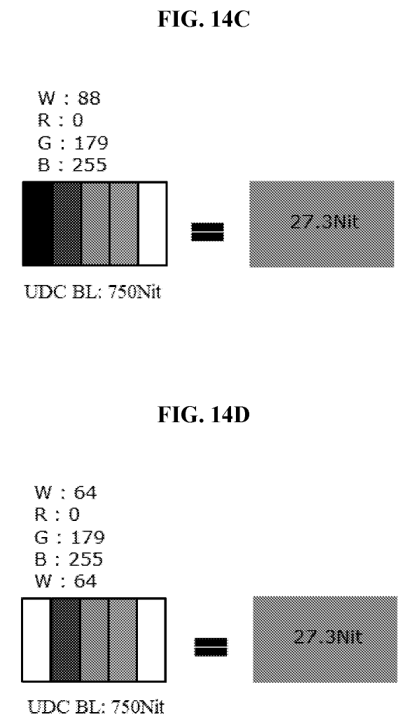

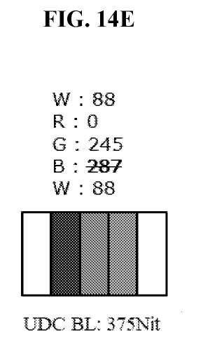

FIGS. 14A- 14E are views illustrating a driving method capable of reducing power consumption in the display device according to another embodiment of the invention.

As shown in FIG. 14A, in a state in which the red sub-pixel PA-R in the sensing area HA is driven at 80 gray, the green sub-pixel PA-G in the sensing area HA is driven at 150 gray, the blue sub-pixel PA-B in the sensing area HA is driven at 200 gray, and all of the white sub-pixels PA-W disposed in the sensing area HA of the liquid crystal display panel 100 are driven to emit black (0 gray), the module light source element 350 is required to be driven at brightness (luminance) of 1,500 nit in order to cause the sensing area HA of the liquid crystal display panel 100 to be displayed with luminance of 27.3 nit in a mixed color.

As shown in FIG. 14B, in a state in which the red sub-pixel PA-R in the sensing area HA is driven at 0 gray, the green sub-pixel PA-G in the sensing area HA is driven at 131 gray, the blue sub-pixel PA-B in the sensing area HA is driven at 187 gray, and one ninth of the white sub-pixels PA-W disposed in the sensing area HA of the liquid crystal display panel 100 are driven at 64 gray, the module light source element 350 is required to be driven at brightness (luminance) of 1,500 nit in order to cause the sensing area HA of the liquid crystal display panel 100 to be displayed with luminance of 27.3 nit in a mixed color.

As shown in FIG. 14C, in a state in which the red sub-pixel PA-R in the sensing area HA is driven at 0 gray, the green sub-pixel PA-G in the sensing area HA is driven at 179 gray, the blue sub-pixel PA-B in the sensing area HA is driven at 255 gray, and one ninth of the white sub-pixels PA-W disposed in the sensing area HA of the liquid crystal display panel 100 are driven at 88 gray, even when the module light source element 350 is driven at brightness (luminance) of 750 nit, the sensing area HA of the liquid crystal display panel 100 is displayed with luminance of 27.3 nit in a mixed color.

As shown in FIG. 14D, in a state in which the red sub-pixel PA-R in the sensing area HA is driven at 0 gray, the green sub-pixel PA-G in the sensing area HA is driven at 179 gray, the blue sub-pixel PA-B in the sensing area HA is driven at 255 gray, and two ninths of the white sub-pixels PA-W disposed in the sensing area HA of the liquid crystal display panel 100 are driven at 64 gray, even when the module light source element 350 is driven at brightness (luminance) of 750 nit, the sensing area HA of the liquid crystal display panel 100 is displayed with luminance of 27.3 nit in a mixed color.

When the module light source element 350 is driven at brightness (luminance) of 1,500 nit as shown in FIGS. 14A and 14B, power consumption is 311.0 mW, whereas when the module light source element 350 is driven at brightness (luminance) of 750 nit as shown in FIGS. 14C and 14D, power consumption is 123.9 mW. It can be seen that power consumption in the cases of FIGS. 14C and 14D is reduced by about 60.2% compared with the cases of FIGS. 14A and 14B.

Accordingly, by controlling driving of the red sub-pixel PA-R, the green sub-pixel PA-G, the blue sub-pixel PA-B, and the white sub-pixel PA-W disposed in the sensing area HA and adjusting the number of white sub-pixels PA-W driven, the sensing area HA may be displayed with target luminance and color while reducing power consumption caused by the module light source element 350.

As shown in FIG. 14E, in a state in which two ninths of the white sub-pixels PA-W are driven at 88 gray, the module light source element 350 may be driven at brightness (luminance) of 375 nit in order to cause the sensing area HA of the liquid crystal display panel 100 to be displayed with luminance of 27.3 nit in a mixed color. However, the red sub-pixel PA-R in the sensing area HA is required to be driven at 0 gray, the green sub-pixel PA-G in the sensing area HA is required to be driven at 245 gray, and the blue sub-pixel PA-B in the sensing area HA is required to be driven at 287 gray. Therefore, when two ninths of the white sub-pixels PA-W are driven at 88 gray, blue gradation representation (287 gray) exceeds a limit (255 gray), and thus, color representation becomes impossible.

That is, when the number of white sub-pixels PA-W driven is increased and a gray level to be represented is increased, a case in which color representation becomes impossible may also occur.

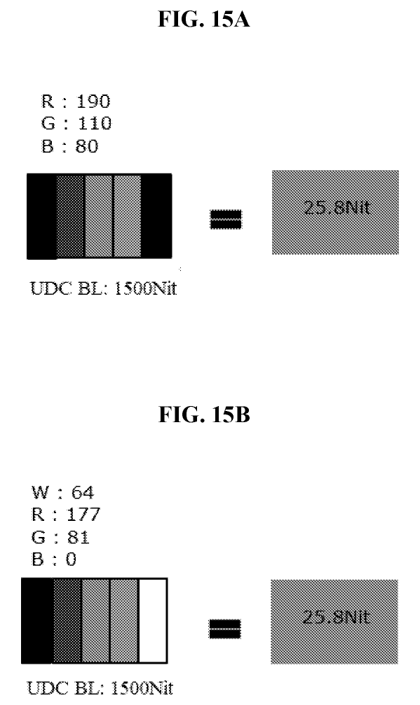

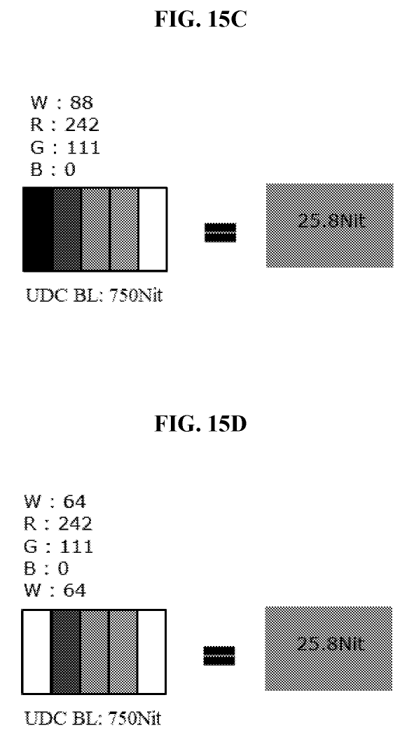

FIGS. 15A- 15D are views illustrating a driving method capable of reducing power consumption in the display device according to still another embodiment of the invention.

As shown in FIG. 15A, in a state in which the red sub-pixel PA-R in the sensing area HA is driven at 190 gray, the green sub-pixel PA-G in the sensing area HA is driven at 110 gray, the blue sub-pixel PA-B in the sensing area HA is driven at 80 gray, and all of the white sub-pixels PA-W disposed in the sensing area HA of the liquid crystal display panel 100 are driven to emit black (0 gray), the module light source element 350 is required to be driven at brightness (luminance) of 1,500 nit in order to cause the sensing area HA of the liquid crystal display panel 100 to be displayed with luminance of 25.8 nit in a mixed color.

As shown in FIG. 15B, in a state in which the red sub-pixel PA-R in the sensing area HA is driven at 177 gray, the green sub-pixel PA-G in the sensing area HA is driven at 81 gray, the blue sub-pixel PA-B in the sensing area HA is driven at 0 gray, and one ninth of the white sub-pixels PA-W disposed in the sensing area HA of the liquid crystal display panel 100 are driven at 64 gray, the module light source element 350 is required to be driven at brightness (luminance) of 1,500 nit in order to cause the sensing area HA of the liquid crystal display panel 100 to be displayed with luminance of 25.8 nit in a mixed color.

As shown in FIG. 15C, in a state in which the red sub-pixel PA-R in the sensing area HA is driven at 242 gray, the green sub-pixel PA-G in the sensing area HA is driven at 111 gray, the blue sub-pixel PA-B in the sensing area HA is driven at 0 gray, and one ninth of the white sub-pixels PA-W disposed in the sensing area HA of the liquid crystal display panel 100 are driven at 88 gray, even when the module light source element 350 is driven at brightness (luminance) of 750 nit, the sensing area HA of the liquid crystal display panel 100 is displayed with luminance of 25.8 nit in a mixed color.

As shown in FIG. 15D, in a state in which the red sub-pixel PA-R in the sensing area HA is driven at 242 gray, the green sub-pixel PA-G in the sensing area HA is driven at 111 gray, the blue sub-pixel PA-B in the sensing area HA is driven at 0 gray, and two ninths of the white sub-pixels PA-W disposed in the sensing area HA of the liquid crystal display panel 100 are driven at 64 gray, even when the module light source element 350 is driven at brightness (luminance) of 750 nit, the sensing area HA of the liquid crystal display panel 100 is displayed with luminance of 25.8 nit in a mixed color.

When the module light source element 350 is driven at brightness (luminance) of 1,500 nit as shown in FIGS. 15A and 15B, power consumption is 311.0 mW, whereas when the module light source element 350 is driven at brightness (luminance) of 750 nit as shown in FIGS. 15C and 15D, power consumption is 123.9 mW. It can be seen that power consumption in the cases of FIGS. 15C and 15D is reduced by about 60.2% compared with the cases of FIGS. 15A and 15B.

Accordingly, by controlling driving of the red sub-pixel PA-R, the green sub-pixel PA-G, the blue sub-pixel PA-B, and the white sub-pixel PA-W disposed in the sensing area HA and adjusting the number of white sub-pixels PA-W driven, the sensing area HA may be displayed with target luminance and color while reducing power consumption caused by the module light source element 350.

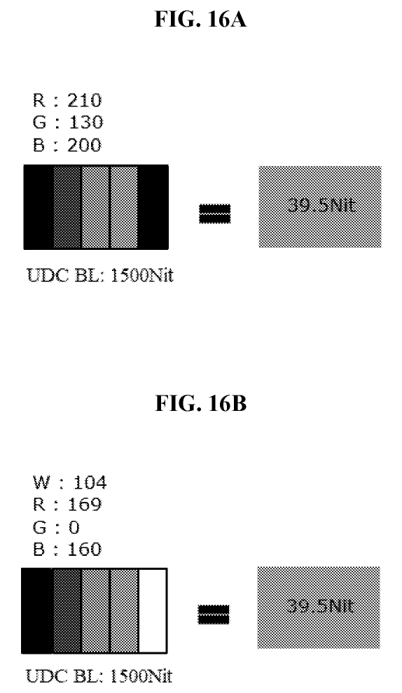

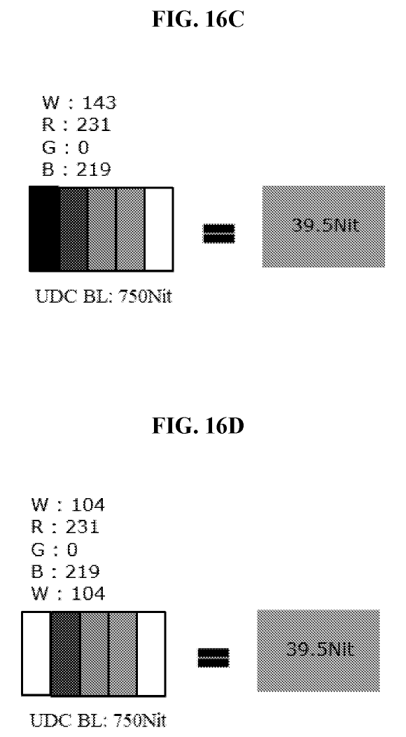

FIGS. 16A -16D are views illustrating a driving method capable of reducing power consumption in the display device according to still another embodiment of the invention.

As shown in FIG. 16A, in a state in which the red sub-pixel PA-R in the sensing area HA is driven at 210 gray, the green sub-pixel PA-G in the sensing area HA is driven at 130 gray, the blue sub-pixel PA-B in the sensing area HA is driven at 200 gray, and all of the white sub-pixels PA-W disposed in the sensing area HA of the liquid crystal display panel 100 are driven to emit black (0 gray), the module light source element 350 is required to be driven at brightness (luminance) of 1,500 nit in order to cause the sensing area HA of the liquid crystal display panel 100 to be displayed with luminance of 39.5 nit in a mixed color.

As shown in FIG. 16B, in a state in which the red sub-pixel PA-R in the sensing area HA is driven at 169 gray, the green sub-pixel PA-G in the sensing area HA is driven at 0 gray, the blue sub-pixel PA-B in the sensing area HA is driven at 160 gray, and one ninth of the white sub-pixels PA-W disposed in the sensing area HA of the liquid crystal display panel 100 are driven at 104 gray, the module light source element 350 is required to be driven at brightness (luminance) of 1,500 nit in order to cause the sensing area HA of the liquid crystal display panel 100 to be displayed with luminance of 39.5 nit in a mixed color.

As shown in FIG. 16C, in a state in which the red sub-pixel PA-R in the sensing area HA is driven at 231 gray, the green sub-pixel PA-G in the sensing area HA is driven at 0 gray, the blue sub-pixel PA-B in the sensing area HA is driven at 219 gray, and one ninth of the white sub-pixels PA-W disposed in the sensing area HA of the liquid crystal display panel 100 are driven at 143 gray, even when the module light source element 350 is driven at brightness (luminance) of 750 nit, the sensing area HA of the liquid crystal display panel 100 is displayed with luminance of 39.5 nit in a mixed color.

As shown in FIG. 16D, in a state in which the red sub-pixel PA-R in the sensing area HA is driven at 231 gray, the green sub-pixel PA-G in the sensing area HA is driven at 0 gray, the blue sub-pixel PA-B in the sensing area HA is driven at 219 gray, and two ninths of the white sub-pixels PA-W disposed in the sensing area HA of the liquid crystal display panel 100 are driven at 104 gray, even when the module light source element 350 is driven at brightness (luminance) of 750 nit, the sensing area HA of the liquid crystal display panel 100 is displayed with luminance of 39.5 nit in a mixed color.

When the module light source element 350 is driven at brightness (luminance) of 1,500 nit as shown in FIGS. 16A and 16B, power consumption is 311.0 mW, whereas when the module light source element 350 is driven at brightness (luminance) of 750 nit as shown in FIGS. 16C and 16D, power consumption is 123.9 mW. It can be seen that power consumption in the cases of FIGS. 16C and 16D is reduced by about 60.2% compared with the cases of FIGS. 16A and 16B.

Accordingly, by controlling driving of the red sub-pixel PA-R, the green sub-pixel PA-G, the blue sub-pixel PA-B, and the white sub-pixel PA-W disposed in the sensing area HA and adjusting the number of white sub-pixels PA-W driven, the sensing area HA may be displayed with target luminance and color while reducing power consumption caused by the module light source element 350.

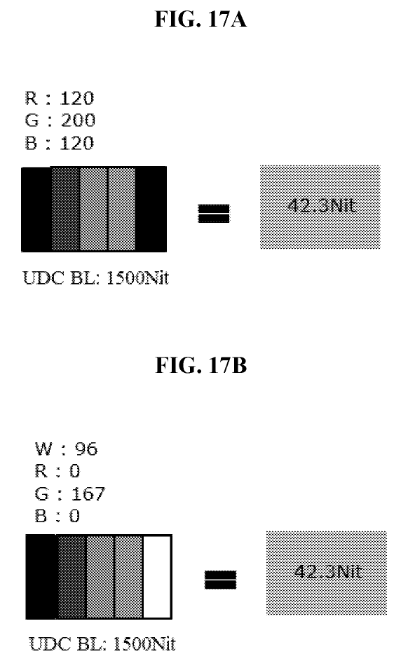

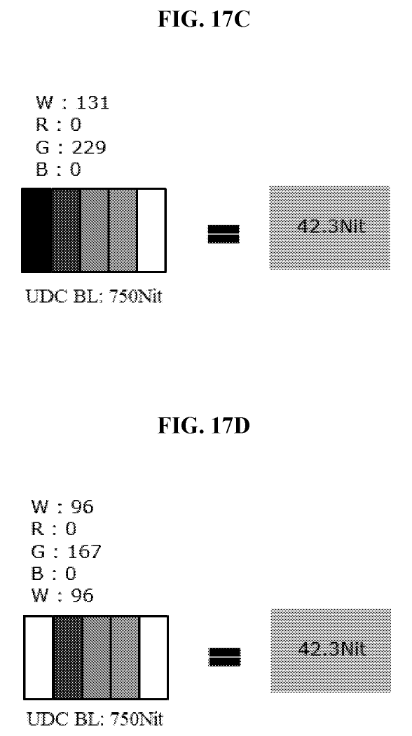

FIGS. 17A-17D are views illustrating a driving method capable of reducing power consumption in the display device according to still another embodiment of the invention.

As shown in FIG. 17A, in a state in which the red sub-pixel PA-R in the sensing area HA is driven at 120 gray, the green sub-pixel PA-G in the sensing area HA is driven at 200 gray, the blue sub-pixel PA-B in the sensing area HA is driven at 120 gray, and all of the white sub-pixels PA-W disposed in the sensing area HA of the liquid crystal display panel 100 are driven to emit black (0 gray), the module light source element 350 is required to be driven at brightness (luminance) of 1,500 nit in order to cause the sensing area HA of the liquid crystal display panel 100 to be displayed with luminance of 42.3 nit in a mixed color.

As shown in FIG. 17B, in a state in which the red sub-pixel PA-R in the sensing area HA is driven at 0 gray, the green sub-pixel PA-G in the sensing area HA is driven at 167 gray, the blue sub-pixel PA-B in the sensing area HA is driven at 0 gray, and one ninth of the white sub-pixels PA-W disposed in the sensing area HA of the liquid crystal display panel 100 are driven at 96 gray, the module light source element 350 is required to be driven at brightness (luminance) of 1,500 nit in order to cause the sensing area HA of the liquid crystal display panel 100 to be displayed with luminance of 42.3 nit in a mixed color.

As shown in FIG. 17C, in a state in which the red sub-pixel PA-R in the sensing area HA is driven at 0 gray, the green sub-pixel PA-G in the sensing area HA is driven at 229 gray, the blue sub-pixel PA-B in the sensing area HA is driven at 0 gray, and one ninth of the white sub-pixels PA-W disposed in the sensing area HA of the liquid crystal display panel 100 are driven at 131 gray, even when the module light source element 350 is driven at brightness (luminance) of 750 nit, the sensing area HA of the liquid crystal display panel 100 is displayed with luminance of 42.3 nit in a mixed color.

As shown in FIG. 17D, in a state in which the red sub-pixel PA-R in the sensing area HA is driven at 0 gray, the green sub-pixel PA-G in the sensing area HA is driven at 167 gray, the blue sub-pixel PA-B in the sensing area HA is driven at 0 gray, and two ninths of the white sub-pixels PA-W disposed in the sensing area HA of the liquid crystal display panel 100 are driven at 96 gray, even when the module light source element 350 is driven at brightness (luminance) of 750 nit, the sensing area HA of the liquid crystal display panel 100 is displayed with luminance of 42.3 nit in a mixed color.

When the module light source element 350 is driven at brightness (luminance) of 1,500 nit as shown in FIGS. 17A and 17B, power consumption is 311.0 mW, whereas when the module light source element 350 is driven at brightness (luminance) of 750 nit as shown in FIGS. 17C and 17D, power consumption is 123.9 mW. It can be seen that power consumption in the cases of FIGS. 17C and 17D is reduced by about 60.2% compared with the cases of FIGS. 17A and 17B.

Accordingly, by controlling driving of the red sub-pixel PA-R, the green sub-pixel PA-G, the blue sub-pixel PA-B, and the white sub-pixel PA-W disposed in the sensing area HA and adjusting the number of white sub-pixels PA-W driven, the sensing area HA may be displayed with target luminance and color while reducing power consumption caused by the module light source element 350.

As is apparent from the above description, a display device and a method of driving the same according to embodiments of the invention have the following effects.

When at least one of white sub-pixels disposed in a sensing area HA emits white, luminance of the sensing area HA may be maintained at the same level even when a light source element supplying light to the sensing area HA is driven at a lower voltage than when all of the white sub-pixels emit black. Accordingly, power consumption of the display device may be reduced.

By controlling driving of the four-color (WRGB) sub-pixels disposed in the sensing area HA and adjusting the number of white sub-pixels PA-W driven, the sensing area HA may be displayed with target luminance and color while reducing power consumption caused by the light source element supplying light to the sensing area HA.

Thus, embodiments of the invention provide a display device and a method of driving the same, in which white pixels without color filters are disposed as pixels in a sensing area to enable high-luminance driving, and target luminance and color are achieved through four-color (WRGB) driving and control of light from an auxiliary light source, thereby significantly reducing power consumption.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a liquid crystal display panel comprising an active area and a sensing area disposed within the active area; and
an optical module disposed under the liquid crystal display panel, the optical module comprising a first light source element configured to supply light to the sensing area and an optical element configured to sense external light through the sensing area,
wherein:
sub-pixels disposed in the active area of the liquid crystal display panel and sub-pixels disposed in the sensing area of the liquid crystal display panel have the same width and length; and
the sub-pixels disposed in the sensing area include at least one white sub-pixel.

2. The display device according to claim 1, wherein the sub-pixels disposed in the active area do not include a white sub-pixel.

3. The display device according to claim 1, further comprising a backlight device disposed between the liquid crystal display panel and the optical module, the backlight device including a light guide plate and a second light source element configured to supply light to the active area through the light guide plate.

4. The display device according to claim 1, wherein substantially one fourth of the number of sub-pixels disposed in the sensing area comprise red, green, and blue sub-pixels, and substantially three fourths of the number of sub-pixels disposed in the sensing area comprise white sub-pixels.

5. The display device according to claim 4, wherein at least one of the white sub-pixels disposed in the sensing area emits white.

6. The display device according to claim 5, wherein, when at least one of the white sub-pixels disposed in the sensing area emits white, the first light source element is driven with lower power consumption than when all of the white sub-pixels disposed in the sensing area emit black.

7. The display device according to claim 1, wherein the sub-pixels in the sensing area comprise first unit pixels including red, green, and blue sub-pixels, and second unit pixels including three white sub-pixels.

8. The display device according to claim 1, wherein the at least one white sub-pixel disposed in the sensing area does not include color filters.

9. The display device according to claim 1, wherein the optical element comprises at least one of a motion sensor, an illuminance sensor, and an ultrasonic sensor.

10. A method of driving a display device including a liquid crystal display panel, including an active area and a sensing area disposed within the active area, and an optical module disposed under the liquid crystal display panel, the optical module including a first light source element configured to supply light to the sensing area and an optical element configured to sense external light through the sensing area, comprising:
driving at least one of white sub-pixels disposed in the sensing area to emit white; and
driving the first light source element with lower power consumption than when all of the white sub-pixels disposed in the sensing area emit black.

11. The method according to claim 10, wherein:
sub-pixels disposed in the active area of the liquid crystal display panel and sub-pixels disposed in the sensing area of the liquid crystal display panel have the same width and length; and
the sub-pixels disposed in the sensing area include at least one white sub-pixel.

12. The method according to claim 11, wherein the sub-pixels disposed in the active area do not include a white sub-pixel.

13. The method according to claim 10, further comprising a backlight unit disposed between the liquid crystal display panel and the optical module,
wherein the backlight unit includes a light guide plate and a second light source element configured to supply light to the active area through the light guide plate.

14. The method according to claim 10, wherein substantially one fourth of the number of sub-pixels disposed in the sensing area comprise red, green, and blue sub-pixels, and substantially three fourths of the number of sub-pixels disposed in the sensing area comprise white sub-pixels.

15. The method according to claim 13, wherein the first light source element and the second light source element are driven to be turned on and off simultaneously.

16. The method according to claim 14, further comprising controlling the first light source element to limit power reduction such that gray levels for the red, green, or blue sub-pixels in the sensing area to achieve a target color do not exceed a maximum gray level of 255.
